(19) United States
(12) Patent Application Publication
(10) Pub. No.: US 2026/0196754 A1
(43) Pub. Date: Jul. 9, 2026

(54) HEADERLESS PCB CONNECTOR SYSTEM AND METHODS

(71) Applicants: Peter Carl Menze, Marquette, MI (US); Stephen Robert Lang, Ishpeming, MI (US); Matthew Menze, Marquette, MI (US)

(72) Inventors: Peter Carl Menze, Marquette, MI (US); Stephen Robert Lang, Ishpeming, MI (US); Matthew Menze, Marquette, MI (US)

(21) Appl. No.: 19/442,836

(22) Filed: Jan. 7, 2026

Related U.S. Application Data
(60) Provisional application No. 63/742,775, filed on Jan. 7, 2025.

(51) Int. Cl. H01R 12/72

(52) U.S. Cl. CPC H01R 12/721

(57) ABSTRACT

A header-less printed circuit board connector system (HLPCBC) comprising novel terminal connectors and printed circuit board (PCB) designs that eliminate the need to solder a stamped blade or PCB header to a PCB. The HLPCBC comprises a plurality of blade terminals formed from the PCB material extending from the PCB. The blade terminals are separated by terminal gaps. A complementary multi-blade terminal connector is used to couple with the terminal connectors. In some forms the multi-blade terminals are arranged in single or multiple planes. Metal plating can extend across the layers of blade terminals to increase strength or can be used for strain relief. The PCBs can be housed in a PCB housing having a blade support wall. The HLPCBC comprises blade terminals on one end of the PCB, whereas in other embodiments, blade terminals extend from opposed ends of the PCB.

### CROSS REFERENCE TO RELATED APPLICATIONS

This application claims priority to Provisional Patent Application No. 63/742,775 filed Jan. 7, 2025, the entire disclosure of which is hereby incorporated by reference and relied upon.

### BACKGROUND OF THE INVENTION

Field of the Invention. The invention relates generally to printed circuit boards (PCBs) and more particularly to printed circuit boards having an integrated header formed from PCB material.

Description of Related Art. Current methods for joining a circuit board to a blade style connector involves soldering a stamped blade terminal or a printed circuit board header having support for multiple blades to a PCP. The PCB and printed circuit board header is then assembled into a case or enclosure that the female blade style connector can be mated with.

Computers sometimes use an ‘edge connector’. In this case, a connector is attached directly to the PCB without a portion of the PCB extending outward like an arm from the PCB.

What is needed are better electrical designs that eliminate the need for soldering a stamped blade terminal or printed circuit board header to a PCB.

### SUMMARY OF THE INVENTION

Disclosed herein is a header-less printed circuit board connector system (HLPCBC) comprising novel terminal connectors and printed circuit board designs that eliminate the need to solder a stamped blade terminal or printed circuit board header to a PCB thereby providing a solution for the aforementioned needs.

In one form, a printed circuit board comprises a plurality of blade terminals formed from the PCB material and wherein the blade terminals are separated by terminal gaps.

In one form, the blade terminals extend from the peripheral edge of the printed circuit board.

In one form, the blade terminals and terminal gap spacing matches the spacing utilized in one or more complementary multi-blade terminal connectors.

In one form, the blade terminals comprise a generally rectangular male profile and size suited to be received in complementary female shaped terminal connectors (terminal receivers) of a multi-blade terminal connector.

In one form, the HLPCBC comprises a blade terminal group comprising a plurality of blade terminals arranged in a plane to be received for electrical mating in female counterparts (terminal receivers) of a multi-blade terminal connector.

In one form, the blade terminals and the terminal receivers in the multi-blade terminal connector are arranged within a single or multiple planes.

In one form, the blade terminals comprise one or more insulator layers sandwiched between or on one or more electrically conductive layers of a PCB.

In one form, a blade terminal can include multi-layer blade terminal plating that is a metal plating that extends between the electrically conductive layers on one or more blade terminals to improve the overall strength of the blade terminal.

In one form, a terminal boundary defines an intersection line of a PCB and blade terminals extending from the PCB.

In one form, one or more conductive layers of one or more blade terminals extend past the intersection line to serve as a strain relief extension onto the PCB to offer strain relief of the blade terminals.

In one form, top and bottom conductive layers of the blade terminals include strain relief extensions whereas intermediate conductive layers are absent of these extensions or have shorter strain relief extensions. This provides space for additional trace circuitry in the intermediate conductive layers of the PCB.

In one form, a blade terminal comprises one or more vias extending through the blade terminal in which the conductive layers are secured by conductive materials such as solder or copper/lead/tin or a pin extending through the vias. These vias can also be used to conduct electricity and/or dissipate heat to other levels.

In one form, a printed circuit board with blade terminals is housed within a PCB cavity of a PCB housing. The PCB housing comprises a blade support wall with blade apertures extending through it. The blade apertures are aligned with the blade terminals that extend through them and the blade support wall supports the blades against fracture. In preferred embodiments, the PCB housing is manufactured from a polymer.

In one form, the PCB housing comprises a receiver wall extending outward from the support wall and defines a receiver cavity configured to receive and support a single or multi-blade terminal connector. In this way, the individual terminal connectors (terminal receivers) mates with the respective blade terminal(s) extending through the blade support wall.

In one form, one or more of the blade support walls are removable or irremovable from the PCB housing. For example, one blade support wall can be molded into the PCB housing (irremovable), whereas a second blade support wall can be fixed in place within the PCB housing after the PCB is seated within the PCB cavity (removable). Both the removable and irremovable blade support wall comprise blade apertures for seating and supporting the blade terminals therein.

In one form, the blade terminals extend from the PCB and adjacent blade terminals are separated by a terminal gap positioned therebetween.

In one form, the width of the terminal gaps between blade terminals extending from a PCB are equal.

In one form, the spacing between midlines of blade terminals extending from a PCB are equal.

In one form, a headerless PCB connector system comprises one or more blade terminals on one end of the PCB, whereas in other embodiments, there are one or more blade terminals extending from opposed ends of the PCB.

In one form, a headerless PCB connector system comprises three or more areas where one or more blade terminals extend from the PCB.

In one form, a plurality of blade terminals are aligned in one or more planes and extend from a PCB to form a blade terminal group.

In one form, two or more PCBs are spaced in parallel planes with blade terminal groups from each PCB aligned for mating with a multi-blade terminal connector. In some embodiments flexible PCBs, pins, or other wiring extends between the spaced PCBs.

In one form, a ferrite bead encircles the PCB of the headerless PCB connector system to dampen noise.

### BRIEF DESCRIPTION OF THE SEVERAL VIEWS OF THE DRAWINGS

These and other features and advantages of the present invention will become more readily appreciated when considered in connection with the following detailed description and appended drawings, wherein each drawing is according to one or more embodiments shown and described herein, and wherein:

FIG. 1 depicts a top perspective view of components joined to a printed circuit board common in the prior art;

FIG. 2 depicts a bottom perspective view of components joined to a printed circuit board common in the prior art;

FIG. 3 depicts a side view of components joined to a printed circuit board common in the prior art;

FIG. 4 depicts an exploded perspective view of components joined to a printed circuit board common in the prior art;

FIG. 5 depicts a perspective view of a headerless PCB connector system;

FIG. 6 depicts an opposing perspective view of the headerless PCB connector system of FIG. 5;

FIG. 7 depicts a perspective view of a multi-blade terminal connector;

FIG. 8 depicts a perspective view of a multi-blade terminal connector separated from engagement with a PCB with PCB housing removed;

FIG. 8B depicts a perspective view of a multi-blade terminal connector separated from a first blade terminal group and a second blade terminal group with PCB housing removed;

FIG. 9 depicts a perspective view of a support collar encircling a first blade terminal group and a second blade terminal group;

FIG. 10 depicts an end view of a PCB housing of a headerless PCB connector system;

FIG. 11 depicts a cross-sectional view through plane F of the PCB housing of the headerless PCB connector system of FIG. 10;

FIG. 12 depicts a top view of the PCB housing of FIG. 10;

FIG. 13 depicts a perspective view of a PCB with ferrite bead;

FIG. 13B depicts a top view of a PCB with terminal gaps;

FIG. 14 depicts a perspective view of a pair of stacked PCBs;

FIG. 15 depicts a partial perspective view of one form of end terminal of a PCB;

FIG. 16 depicts a partial perspective view of another form of end terminal of a PCB;

FIG. 17 depicts a partial perspective view of another form of end terminal of a PCB;

FIG. 18 depicts a partial perspective view of another form of end terminal of a PCB;

FIG. 19 depicts a partial perspective view of another form of end terminal of a PCB;

FIG. 20 depicts a partial perspective view of end terminals having vias with insulative material removed;

FIG. 21 depicts a partial perspective view of an end terminal with insulative material removed.

### DETAILED DESCRIPTION OF SELECTED EMBODIMENTS OF THE INVENTION

Select embodiments of the invention will now be described with reference to the Figures. Like numerals indicate like or corresponding elements throughout the several views. The terminology used in the description presented herein is not intended to be interpreted in any limited or restrictive way, simply because it is being utilized in conjunction with detailed description of certain specific embodiments of the invention. Furthermore, embodiments of the invention may include several novel features, no single one of which is solely responsible for its desirable attributes or which is essential to practicing the invention described herein.

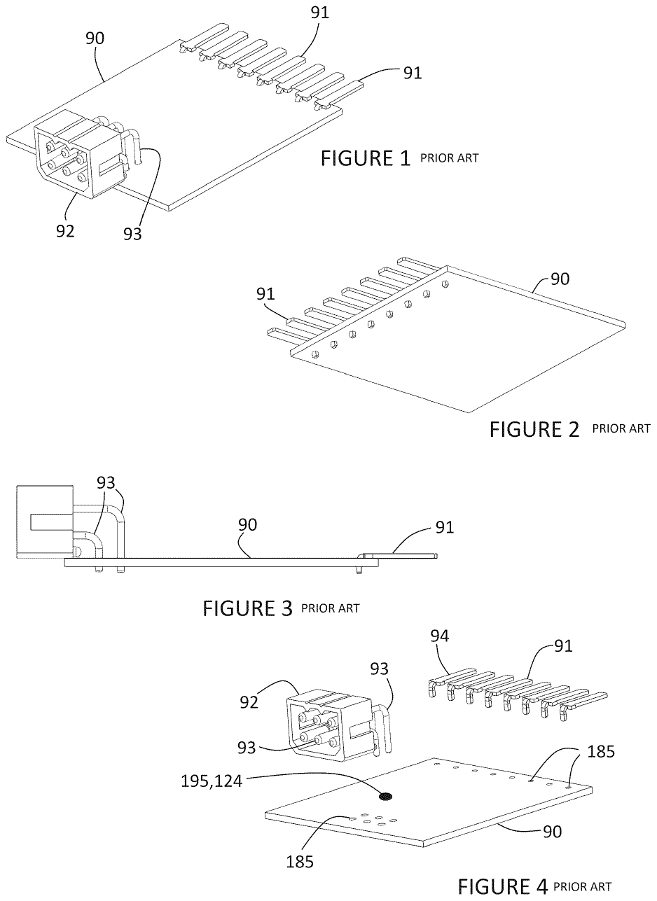

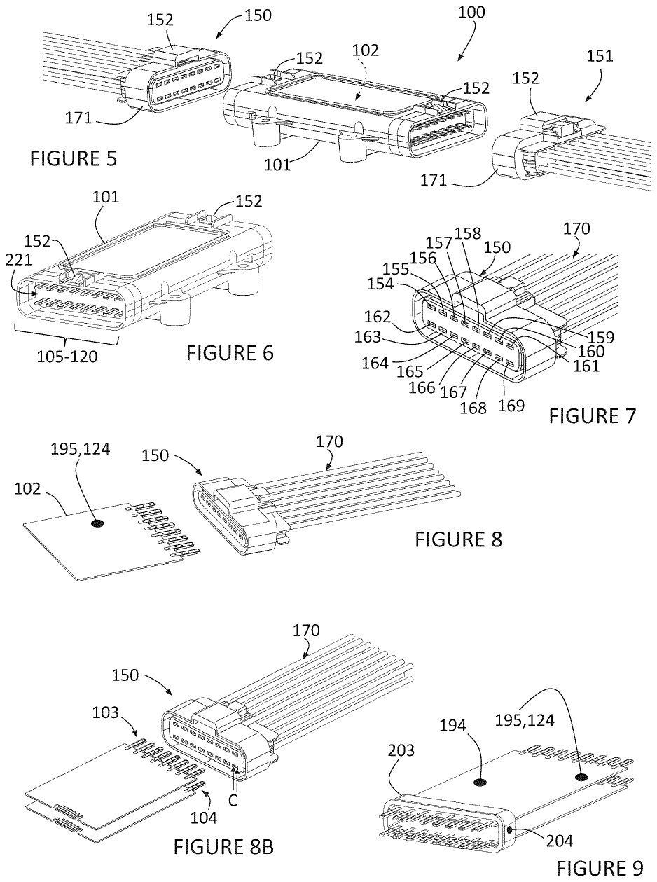

Depicted in FIGS. 1-4 are PCBs 90 commonly found in the prior art. To engage the electronics from the PCB with electrical connectors, it is common to utilize a plurality of headers 91 that have a flat blade portion 94 that slides in a complementary electrical terminal connector. The headers are typically soldered into solder apertures 185 in the PCB 90. In some cases, an electrical coupler 92 with coupler leads 93 extending from the back of it is again soldered into place on the PCB. This is a labor-intensive process, requiring more parts, and with a header that is ultimately somewhat fragile. The headerless PCB connector system disclosed herein builds blade terminals into the manufacture of the PCB foregoing the extra labor and parts while producing a stronger, simpler, and superior product.

Depicted in FIG. 5 is a headerless PCB connector system 100 (HLPCBC) comprising novel blade terminals, terminal connectors (receivers), PCB housing, multi-blade terminal connectors, and printed circuit board designs that eliminate the need to solder a stamped blade terminal or PCB header to a PCB thereby providing a solution for the aforementioned needs.

In one embodiment, a printed circuit board 102 (PCB) comprises a plurality of blade terminals formed from the PCB material (FIG. 13) and wherein the blade terminals (i.e. 105-120) are separated by terminal gaps (i.e. 132-145) as depicted in FIG. 13B. In preferred embodiments, the blade terminals and terminal gap spacing matches the spacing of terminal connectors (receivers) utilized in the complementary multi-blade terminal connectors (i.e. first multi-blade terminal connector 150, second multi-blade terminal connector 151).

The blade terminals have a generally rectangular male profile and size suited to be received in complementary female shaped terminal connectors (receivers) of single or multi-blade terminal connectors (i.e. 150). As depicted in FIG. 14 for example, a pair of stacked PCBs 102 are depicted with blade terminals (first blade terminal 105, second blade terminal 106, third blade terminal 107, fourth blade terminal 108, fifth blade terminal 109, sixth blade terminal 110, seventh blade terminal 111, eighth blade terminal 112, ninth blade terminal 113, tenth blade terminal 114, eleventh blade terminal 115, twelfth blade terminal 116, thirteenth blade terminal 117, fourteenth blade terminal 118, fifteenth blade terminal 119, and sixteenth blade terminal 120). Note that half of the blade terminals of PCB 102 extend from an opposing end of PCB 102. As noted in the Figure, the blade terminals and PCB all reside generally in the same plane D. Collectively, the blade terminals on one end of the PCB can be considered a first blade terminal group 103, and the blade terminals on the opposing end of the PCB can be considered the second blade terminal group 104. As depicted in FIG. 14 the PCBs can be stacked in parallel planes (plane D, plane E) such that two or more blade terminal groups can be configured to be received for electrical mating in female counterparts of a multi-blade terminal connector (i.e. first multi-blade connector 150, second multi-blade connector 151).

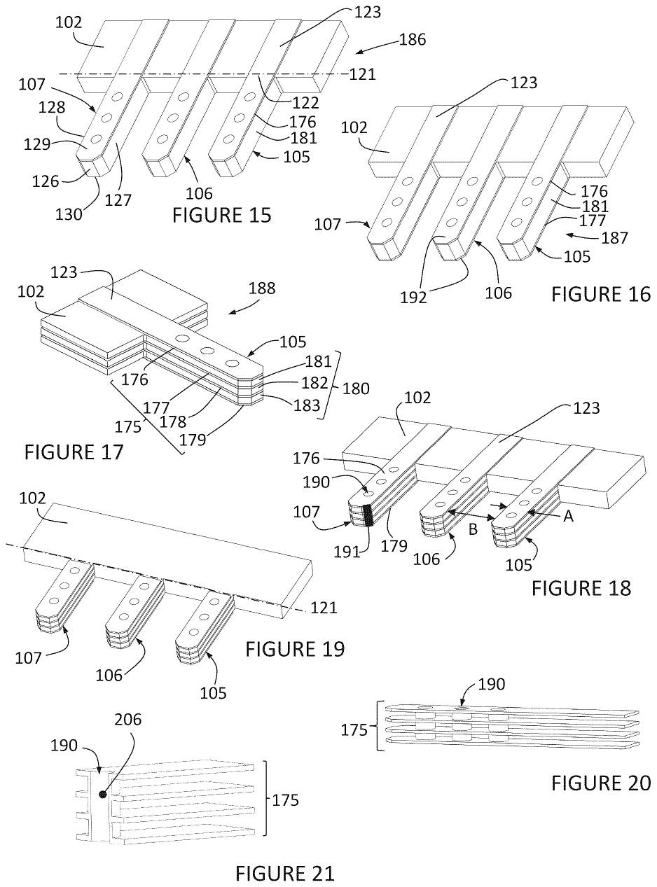

Depicted in FIGS. 15-19 are various embodiments of blade terminals. The blade terminals comprise one or more insulator layers sandwiched between or on one or more electrically conductive layers of a PCB. The layers are bonded together. For example, depicted in FIG. 15 is a first blade terminal 105, second blade terminal 106, and third blade terminal 107, extending from a single sided PCB 186. Note in this example that the blade terminals are constructed from a first insulator layer 181 and a first conductive layer 176 (thus single sided). The blade terminal in FIG. 16 is like that of FIG. 15 but includes a second conductive layer 177 such that the insulator layer is sandwiched between the top and bottom conductive layers and is referred to as a double-sided PCB 187 or said to have opposed blade terminals 192. The blade terminal can include several more layers alternating between conductive layers 175 and insulator 180 layers (i.e. multi-layer PCB 188). For example, the blade terminal in FIG. 17 includes a second insulator layer 182, a third conductive layer 178, a third insulator layer 183, and a fourth conductive layer 179. Note in some embodiments, one or more conductive layers extend into the PCB (FIG. 18), whereas as depicted in FIG. 18, only some of the conductive layers extend into the PCB. In some cases, the PCB will include a silkscreen layer 189 to provide identification, logos, and other information about the PCB.

In some embodiments, a blade terminal includes a multi-layer terminal plating 191 that is a metal plating that spans one or more electrically conductive layers on one or more blade terminals to improve the overall strength of the blade terminal. For example, the alternating layers are exposed on a first blade side 127, a second blade side 128, and at the blade end 126. FIG. 18 depicts multi-terminal plating 191 extending between the first conductive layer 176 and fourth conductive layer 179 and can be bonded as well to intermediate conductive layers. The blade terminals have an upward facing blade top 129 surface as well as a downward facing blade bottom 130 surface.

A terminal boundary 121 defines an intersection line of a PCB 102 and blade terminals extending from the PCB. In some embodiments, one or more conductive layers 175 of one or more blade terminals (105-120) extend from terminal base 122 of the blade terminal past terminal boundary 121 as a strain relief extension 123 onto the PCB 102 to offer strain relief of the blade terminals. In preferred embodiments, this strain relief extension 123 is present on the uppermost and bottommost conductive layer, however, it can include any one or more of the conductive layers. Since each adjacent layer is bonded to each other, the strain relief extension provides for a much stronger blade terminal. Again, top and bottom conductive layers of the blade terminals can include strain relief extensions 123 whereas intermediate conductive layers can be absent or have shorter strain relief extensions. Shorter or absent strain relief extensions provide space for additional circuit trace 124 in the intermediate conductive layers. It is preferred that the insulative layers are continuous through the blade terminals into the PCB.

In some embodiments, a blade terminal (i.e. 103-120) comprises one or more PCB vias 190 extending through the blade terminal in which the conductive layers 175 are secured by a conductive joiner 206 comprising conductive materials such as solder or copper/lead/tin or a pin extending through the PCB vias. This feature can again strengthen the blade terminal. These vias can also be used to conduct electricity and/or dissipate heat to other levels. The PCB vias 190 can be used to distribute electrical signals between conductive layers. FIGS. 20 and 21 depict PCB vias with insulative layers removed.

As depicted in FIG. 5, a printed circuit board 102 with blade terminals can be housed within a PCB cavity 223 of a PCB housing 101. PCB housing 101 can utilize one or more mounting pods 196 to secure the PCB housing to an anchoring surface. PCB housing 101 envelopes the PCB and comprises a first blade support wall 212, and in some cases a second blade support wall 213 or additional blade support walls as needed for the application to enclose ends of the housing. The blade support walls have one or more blade apertures 218 defined by a blade aperture face 219 extending between an inner support face 216 and outer support face 217 of the blade support wall. The blade apertures are aligned with and configured in size and shape to support the blade terminals that extend through them from a PCB seated within the PCB cavity.

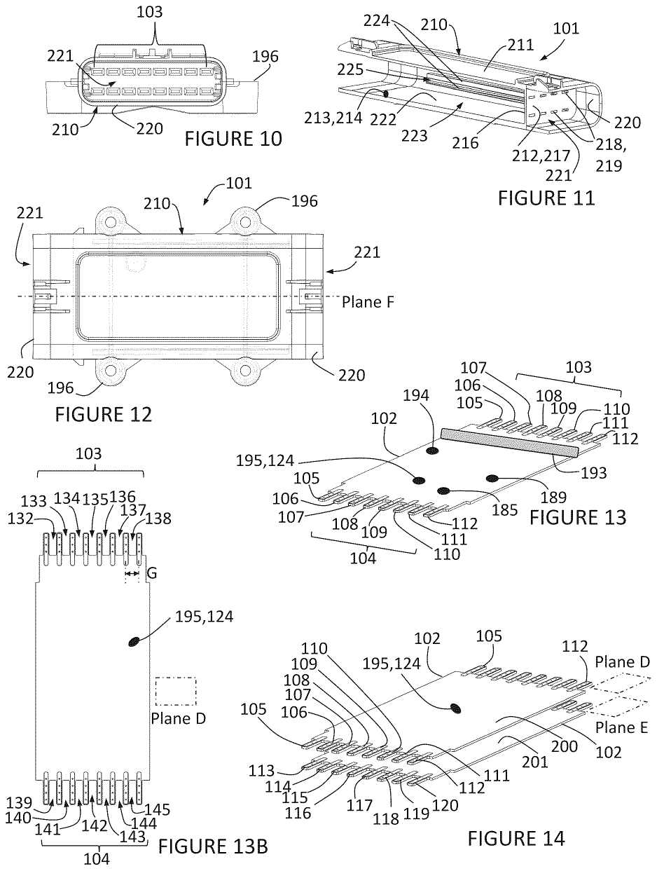

As noted in FIGS. 10-12, PCB housing 101 comprises a shell body 210 having an outer surface 211. The shell body comprises a receiver wall 220 extending from first blade support wall 212 (or second blade support wall 213 etc.) and defines a receiver cavity 221 configured to receive and support a single or multi-blade terminal connector (i.e. first multi-blade terminal connector 150, second multi-blade terminal connector 151, etc.). In this way, the respective terminal connector mates with the respective blade terminal(s) extending through the respective blade support wall. In some embodiments, one or more of the blade support walls are removable or irremovable. For example, a first blade support wall 212 can be molded into the PCB housing as depicted in FIG. 11, whereas a second blade support wall 213 can be fixed in place within the PCB housing and held using a support wall interlock 214 after the PCB 102 is seated within the PCB cavity 223. The PCB cavity is defined by PCB cavity face 222 which in this case is a generally rectangular block space. Both the removable and irremovable blade support walls comprise blade apertures for seating and supporting the blade terminals within. Located on or within PCB cavity face 222 can be one or more PCB positioners 224. For example, these positioners can be in the form of a groove or bosses that assist in holding the PCB in a secure position within PCB cavity 223. In the FIG. 11 embodiment, the PCB positioners are in the form of a pair of elongate bosses that define a guide path 225 for the PCB to slide during assembly and then to be seated in. The PCB is slid along and captured between the guide paths on each side of the PCB cavity and advanced forward until the blade terminals extend fully through the blade apertures.

As depicted in FIG. 13B, the blade terminals extend from the PCB and are separated by terminal gaps. In this case, there are eight terminals (which can vary depending on the application) on each end of the PCB and therefore seven terminal gaps (first terminal gap 132, second terminal gap 133, third terminal gap 134, fourth terminal gap 135, fifth terminal gap 136, sixth terminal gap 137, seventh terminal gap 138). On the opposed end of the PCB 102 are seven more terminal gaps (eighth terminal gap 139, ninth terminal gap 140, tenth terminal gap 141, eleventh terminal gap 142, twelfth terminal gap 143, thirteenth terminal gap 144, and fourteenth terminal gap 145). In preferred embodiments, terminal gap widths ‘B’ between the blade terminals (FIG. 18) extending from a PCB are equal, however, in other embodiments this distance can vary. Likewise, the spacing between midlines of blade terminals ‘G’ (FIG. 13B) extending from a PCB are equal but can vary in alternative embodiments. Similarly, the width of the blade terminals ‘A’ (FIG. 18) are preferably equal but can vary in alternative embodiments. Similarly, the terminal connector (receiver) width ‘C’ is sufficient to receive the respective blade terminal.

As depicted in at least FIG. 5 and FIG. 14, two or more PCBs (i.e. first PCB 200, second PCB 201) can be spaced in parallel planes (i.e. plane D and plane E) with blade terminal groups (first blade terminal group 103, second blade terminal group 104) from each PCB aligned for mating with a multi-blade terminal connector (i.e. first multi-blade terminal connector 150, second multi-blade terminal connector 151). In some embodiments flexible PCBs, pins, or other wiring extends between the spaced PCBs.

The multi-blade terminal connectors have a plug body 171 (FIG. 5) with a configuration that complements mating with the respective PCB housing such that the blade terminals engage with the respective terminal connector/receiver (i.e. first terminal connector 154, second terminal connector 155, third terminal connector 156, fourth terminal connector 157, fifth terminal connector 158, sixth terminal connector 159, seventh terminal connector 160, eighth terminal connector 161, ninth terminal connector 162, tenth terminal connector 163, eleventh terminal connector 164, twelfth terminal connector 165, thirteenth terminal connector 166, fourteenth terminal connector 167, fifteenth terminal connector 168, sixteenth terminal connector 169). Depicted here is a multi-blade terminal connector having sixteen terminal connectors (receivers) arranged in two rows of eight, however, those skilled in the art will recognize that this quantity can vary as well as the number of rows. In other words, a two row plug will mate with two stacked PCBs in a PCB housing, whereas a single row plug will mate with a single PCB in a PCB housing. Extending from each terminal connector is an insulated conductor 170 or sometimes non-insulted conductor. In either case they can alternatively be in the form of a flexible PCB. A connector lock 152, is utilized on the multi-blade terminal connector (i.e. 150, 151) and the PCB housing 101 to releasably secure the multi-blade terminal connector to the PCB. It should be noted that the ‘multi-blade terminal connectors’ and complementary blade terminals can comprise a single blade as an alternative to multi-blades.

In some embodiments, a ferrite bead 193 (FIG. 13) encircles the PCB 101 of the headerless PCB connector system 100 to dampen noise. Also in some embodiments, a support collar 203 is utilized to support one or more PCBs within a PCB housing 101. A terminal group lock 204 can be used to hold the support collar in position with respect to the PCB housing using features such as a ball detent or boss and notch. Support collar 203 can be molded in a ferrite compound that HLPCBC terminals pass through to provide EMI, RFI, and TVS, noise suppression. Additionally, first blade support wall 212 or other blade support walls such as second blade support wall 213 can be a removable part that is molded in a ferrite compound that the HLPCBC terminals pass through to provide EMI, RFI, and TVS, noise suppression.

As commonly done, solder 184 can be utilized to electrically connect and secure electrical components 195 to PCB 102 within component mount holes 194 or other solder apertures.

It is noted that the terms “substantially” and “about” and “generally” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

The foregoing invention has been described in accordance with the relevant legal standards, thus the description is exemplary rather than limiting in nature. Variations and modifications to the disclosed embodiment may become apparent to those skilled in the art and fall within the scope of the invention.

What is claimed is:

1. A headerless printed circuit board connector system comprising:
a printed circuit board of alternating layers of electrically conductive and electrically non-conductive material;
a plurality of blade terminals formed and extending from said conductive and non-conductive material of said printed circuit board;
said plurality of blade terminals extending coplanar from said printed circuit board;
said blade terminals separated by terminal gaps defining individual blade terminals;
a multi-blade terminal connector operable for receiving said plurality of blade terminals;
said multi-blade terminal connector housing a plurality of terminal connectors operable to electrically couple with respective plurality of blade terminals; and, wherein each terminal connector is coupled to one or more insulated conductor.

2. The headerless printed circuit board connector system of claim 1 wherein spacing of said terminal gaps complements spacing utilized between said multi-blade terminal connectors.

3. The headerless printed circuit board connector system of claim 1 wherein said blade terminals comprise a generally rectangular male profile and size suited to be received in complementary female shaped terminal connectors of said multi-blade terminal connectors.

4. The headerless printed circuit board connector system of claim 1 wherein said blade terminals and said terminal connectors in said multi-blade terminal connector are arranged within a single or multiple planes.

5. The headerless printed circuit board connector system of claim 1 wherein said blade terminals comprise one or more insulator layers sandwiched between or on one or more electrically conductive layers of a PCB.

6. The headerless printed circuit board connector system of claim 1 further comprising:
multi-layer blade terminal plating;
said multi-layer blade terminal plating in a form of metal plating that extends between the electrically conductive layers on one or more blade terminals to improve the overall strength of said blade terminal.

7. The headerless printed circuit board connector system of claim 1 further comprising:
a terminal boundary defined by the intersection of said printed circuit board and said blade terminals extending from said printed circuit board; and,
wherein one or more of said electrically conductive layers of one or more said blade terminals extend past said terminal boundary and is operable as a strain relief extension onto said printed circuit board.

8. The headerless printed circuit board connector system of claim 1 wherein top and bottom electrically conductive layers of said blade terminals include strain relief extensions into said printed circuit board and whereas intermediate electrically conductive layers are absent of or have shorter strain relief extensions into said printed circuit board.

9. The headerless printed circuit board connector system of claim 1 further comprising:
at least one via;
said at least one via extending through at least one of said blade terminals; and,
wherein said electrically conductive layers are secured by electrically conductive materials extending through said at least one via.

10. The headerless printed circuit board connector system of claim 1 further comprising:
a PCB housing;
said PCB housing comprising a PCB cavity defining an internal space for seating said printed circuit board therein;
said PCB housing comprising at least one blade support wall;
a plurality of blade apertures extending through said at least one blade support wall; and,
wherein said blade terminals extend through and are supported by said blade apertures.

11. The headerless printed circuit board connector system of claim 10 further comprising:
a receiver wall;
said receiver wall extending outward from said blade support wall to define a receiver cavity operable to receive and support a multi-blade terminal connector.

12. The headerless printed circuit board connector system of claim 10 wherein said at least one blade support wall is in the form of opposing blade support walls positioned on opposing ends of said PCB housing.

13. The headerless printed circuit board connector system of claim 10 wherein said at least one blade support wall is removeable from said PCB housing.

14. The headerless printed circuit board connector system of claim 1 wherein said blade terminals extend from opposing ends of said printed circuit board.

15. The headerless printed circuit board connector system of claim 1 wherein said blade terminals extend from three or more sides of said printed circuit board.

16. The headerless printed circuit board connector system of claim 1 further comprising:
a second printed circuit board;
said second printed circuit board spaced in parallel planes from said printed circuit board; and,
wherein at least one of flexible printed circuit boards, pins, and wiring extends between said printed circuit board and said second printed circuit board.

17. The headerless printed circuit board connector system of claim 1 further comprising:
a ferrite bead;
said ferrite bead encircling said printed circuit board.

18. A printed circuit board comprising:
alternating layers of conductive and non-conductive material;
a plurality of blade terminals formed from said conductive and non-conductive material of said printed circuit board;
said plurality of blade terminals positioned coplanar with said printed circuit board; and,
wherein said blade terminals are separated by terminal gaps within said printed circuit board defining individual blade terminals.

19. The printed circuit board of claim 18 wherein said blade terminals have a length that is greater than the width of each blade terminal wherein said width is defined by the distance between adjacent terminal gaps.

20. The printed circuit board of claim 18 wherein said blade terminals extend from opposing sides of said printed circuit board.
